(19) United States
(12) Patent Application Publication
(10) Pub. No.: US 2013/0032527 A1
(43) Pub. Date: Feb. 7, 2013

(54) SYSTEM OF CONTINUOUS SAMPLING OF FILTRATION OF A MUD

(71) Applicant: Antonio Calleri, Milano (IT)

(72) Inventor: Antonio Calleri, Milano (IT)

(21) Appl. No.: 13/442,756

(22) Filed: Apr. 9, 2012

(30) Foreign Application Priority Data
Aug. 4, 2011 (IT) MI2011A000574

(51) Int. Cl. B01D 29/64; B01D 29/62

(52) U.S. Cl. 210/413; 210/407

(57) ABSTRACT

A system for filtering and sampling, preferably but not exclusively, of oil drilling mud for the purpose of analyzing the gaseous component contained in debris produced by well-drilling and transported by said mud. The system is provided with a filtering surface developed in three dimensions and with various methods for cleaning the filtering surface with which any contact is avoided between the cleaner and the filtering surface. This prevents further and excessive incrustations of debris on the meshes of the filter and avoids an undesirable passage of air in the aspiration pipe when the filter is partially immersed.

### CROSS-REFERENCE TO RELATED APPPLICATION

This application is a national application and claims the benefit of the priority filing date in Italian patent application number MI2011A000574 filed on Apr. 8, 2011 in the name of GEOLOG S.p.A.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a system for filtering and sampling, preferably, but not exclusively, of oil drilling mud for the purpose of analyzing gaseous components contained in debris produced by well drilling and transportation of mud. Said system provides for the use of at least one three-dimension filtering surface and different solutions for cleaning said filtering surface. In this way, it is possible to prevent excessive incrustations of debris on the filter's meshes, as well as to avoid an undesirable passage of air in the aspiration pipe when the filter is partially immersed.

During well drilling, circulation of a fluid is performed in the drilling hole. This fluid has different functions. One of which is to return debris produced by the action of the drill bit to the surface. There, the composition of the relative fluid and gaseous elements of the debris can be analyzed.

The drilling fluid is aspirated from a tank and sent under pressure by a pump which feeds the fluid into drill rods, through which the fluid reaches the bottom of the hole where the drill bit is located. At this point, the mud returns upwards due to the relative movement between the drill rods and the well's walls. Once the mud has risen to the surface, the fluid and what is contained therein, enter pipes known as the “flow line.” At the end of the “flow line,” a system of vibrating screens separates the fluid from solid debris in order to re-feed clean fluid into recirculation pipes in the direction of the start tank.

During “flow line” transit, a pump provides for the aspiration of an appropriate flow of fluid, which is then fed into a cylindrical degasser with mechanical or pneumatic power supply, wherein gas is separated by centrifugal action. Said gas is subsequently diluted with air and analysed by appropriate apparatuses. The remaining fluid exiting the degasser's outlet pipe union is re-fed towards the zone of the vibrating screens.

To avoid excessive wear and possible pump malfunction, the fluid entering the aspiration pipe towards the pump should be free from large solid components, which, in the case of oil drilling debris, can reach a few centimetres. To separate said solid components, filters are used made up of perforated surfaces and provided with appropriate openings. The openings are of such dimensions as to prevent the passage of solid agglomerates having an average diameter greater or equal to that of the openings.

Passage openings of overly reduced extension cause rapid clogging of the filter, thereby precluding an adequate supply of sampling pump. These filters are state of the art and provided with knives actuated mechanically for the removal of the incrustations. However, the knives can cause jamming of the cut-off particles rendering the filter unusable. Moreover, the inevitable contact between the knives and meshes of the filter, both made up of metallic material, causes undesirable abrasions to both knives and meshes. This limits the durability and performance of said filter.

Therefore, the object of the present invention is that of providing an adequate system of filtration capable of both avoiding a further clogging of the passage openings following the same mechanical action of cleaning the meshes of the filter, and avoiding the abrasion of the meshes and knives caused by reciprocal contact between them.

Another disadvantage of known filters is the passage of air inside the filter. Since mud occupies only a minor part of the generic section of the flow line and the part above it is filled with air, when the filter is partially immersed in the zone of the debris, it is inevitable that a passage of air occurs in said filter, thus harming the analysis required.

State of the art filters have excessive dimensions such that they can be immersed in the fluid only partially. Consequently, because the upper part is immersed in air, an undesirable passage of air occurs in the filter itself.

Therefore, a further object of the present invention is to avoid a passage of air in the aspiration piping towards the pump when the filter is partially immersed.

Moreover the surfaces of filters known today, used preferably for the sampling of oil drilling mud, usually develop in two single dimensions. This requires considerable space when an adequate passage surface is sought. Another object of the present invention, therefore, is to provide a filter which has a large passage surface with fairly reduced space by using a filtering surface developed in three dimensions.

### SUMMARY

These objects are achieved by means of the development of a system of filtration provided with at least one filtering surface developed in three dimensions, the use of an innovative system of cleaning the meshes of said surface such that any contact is avoided between the instrument which performs the cleaning of the meshes and the filter itself, and an adequate placement of the fluid inlet section in the aspiration pipe.

A filtering surface is therefore adopted, preferably cylindrical and coaxial to the end part of the aspiration pipe which is preferably perpendicular to the direction of the flow of mud, and therefore also to the surface of the flow line which is tangent to said flow. Said filtering surface is, moreover, preferably provided with continuous slit openings, obtained preferably by winding metal wires around elongated and taut cylindrical elements arranged parallel along a circumference so as to form a cylindrical surface. The metal wire wound transversely to said cylindrical elements is provided with a trapezoidal section so as to oppose, by means of the oblique sides of said section, the accumulation of solid particles on the filter.

At the lower end of the aspiration pipe, one or more slots are formed which allow the entry of fluid of such dimensions as to allow the passage of gas bubbles which composition is to be analysed. The particular placing of said slots on the lower end of the pipe prevents the passage of air when the filtering surface is partially immersed.

To clean the filtering surface, a body is used, preferably extraneous to said surface and of variable configuration on the basis of the solution adopted. Said body is positioned for all solutions, and in such a way that the cleaning surface is detached from said filtering surface during cleaning. Said body is intended for the cleaning of the filter (hereinafter referred to more simply as “cleaner”), and must necessarily move in relation to the filter itself.

The mechanical energy necessary for the cyclical movement of the cleaner is obtained via a drive shaft with pneumatic drive or actuated by means of any other type of known power supply which drives, preferably via a gear transmission, another shaft, preferably external and coaxial both to the aspiration pipe and to the filtering surface (hereinafter said “secondary shaft”). The cleaner follows the circular movement of the latter via a ring provided with a line of separation which defines two arms of the same ring which can be tightened and attached to one another by means of a screw or other known system, so that said ring tightens around said secondary shaft. Said ring, which can also have a shape which is not perfectly circular, is restrained to the cleaner via a known attachment system which can be a screw or can constitute a single body with this cleaner.

The complete sampling system can also be equipped with some flanges, preferably circular, both traversed by the secondary shaft and by the aspiration pipe (which functions as a support for this system), as well as casings having the function of protecting said sampling system from possible impact and from mud. This system can be easily transported and installed.

Said installation takes place preferably by means of a stub pipe made up of two metal rings in which one rests on the surface of the flow line and is welded thereto by means of a known method of welding, and the other screws to the first and tightens around one of said casings.

As far as the cleaner is concerned, a first solution provides for the use of a blade, preferably in bronze, made up of an elongated beam with an axis preferably parallel to the axis of the filtering cylinder and section, and preferably triangular, having two sides respectively tangent and perpendicular to the filtering surface. The third side is slanted in relation to said surface and intended to avoid an excessive quantity of solid particles accumulating in front of said blade, since the slant of said side encourages the removal of said particles.

The blade follows the circular movement of the secondary shaft and detaches the debris jammed on the meshes of the preferably cylindrical filtering surface. The blade rotates around said filtering surface which stays still and is placed at a calculated distance from the filtering surface. The distance between the blade and the filtering surface is sufficiently small to allow the cleaning of said filtering surface, maintaining a total absence of contact between cleaner and filter. This distance, following experiments performed, can be contained within a range of 0.5 mm to 5 mm.

In the presence of debris of a certain size, the blade risks breaking when solid agglomerates of elongated shape are jammed between the blade and the aspiration pipe passing through the holes of the filter, or between the blade and one or more small protection columns placed around the filtering surface. To avoid this, a preferably cylindrical surface, rotating preferably coaxial and external in relation to the filtering surface, can be used as the cleaner. This is the second solution proposed. Said rotating surface is provided with one or more circular holes and rotates around the filtering surface which stays still in order to detach the debris jammed on the meshes of said filtering surface.

Any particularly bulky solid bodies which may jam between the aspiration pipe and the holes of the cleaner cylinder, or between the latter and the small protection columns, would be cut due to the angular movement of said cleaner cylinder. The solid debris detached from the surface of the filter, by means of the surface of the cleaner cylinder, exits from the holes of the latter.

The cleaner cylinder extends over the entire surface of the filtering cylinder, at a calculated distance such as to allow the cleaning of the solid agglomerates attached to the meshes of the filter, yet sufficient for ensuring a total absence of contact between the surfaces of the filter and cleaner. Said distance, following experiments performed, can be comprised within a range of 0.5 mm to 5 mm.

Finally, to increase the efficiency of the cleaner, the third solution proposed provides for the holes of the cleaner cylinder to be slots with a preferably helical shape arranged along the surface. The shape of the helical slots, in addition to allowing debris detached from the meshes of the filter to exit, tends to push said debris downwards so that it exits from a slit. Said slit is preferably circular, and positioned between the base of the cleaner cylinder and an underlying protection plate. The protection plate is preferably circular and restrained with a known system both to the base of the filtering surface and to the cleaner.

These features of the present invention will be made clearer on reading the following detailed description of some preferred embodiments of the present invention to be considered by way of a non-limiting example of the more general concepts claimed.

### FIGURES

FIG. 1 is a schematisation of the system of sampling where the blade in bronze is used as the cleaner.

FIG. 2 is a view of the filter wherein it is possible to note the arrangement of the inlet slots of the aspiration pipe.

FIG. 3 is a view of the filter where a rotating cylinder, coaxial to the filter, provided with circular holes, is used as the cleaner.

FIG. 4 is a view of the filter where a rotating cylinder, coaxial to the filter, provided with helical slots, is used as the cleaner.

### DETAILED DESCRIPTION

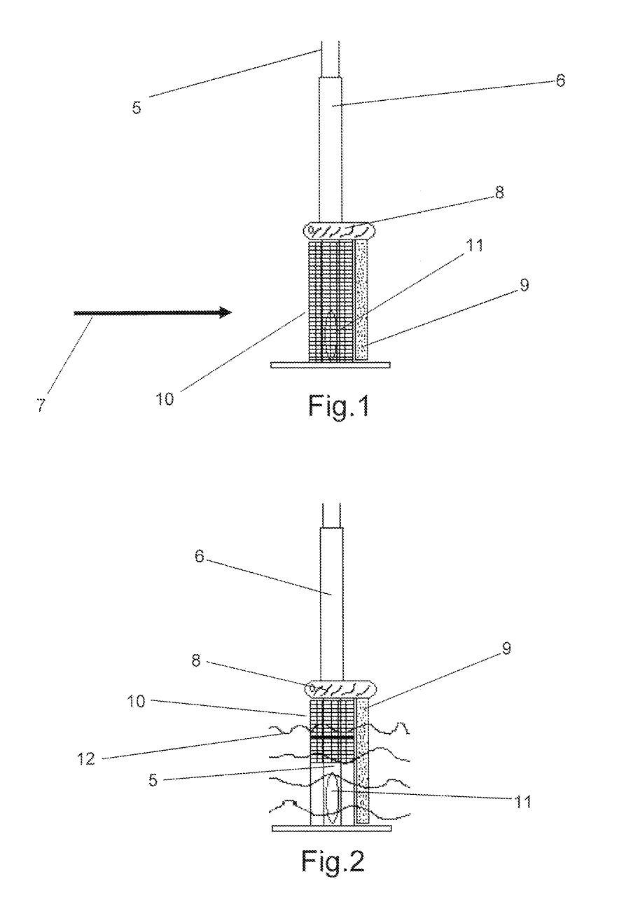

In FIG. 1 the aspiration pipe 5, coaxial to the secondary shaft 6, is perpendicular to the flow of mud indicated by the arrow 7 and inside said secondary shaft 6. The secondary shaft 6 rotates around said aspiration pipe 5 because of the drive shaft (not shown), and by means of the ring 8, which tightens around said secondary shaft 6, moves the cleaner 9, which is made up in this case of a blade preferably in bronze, distanced from the filtering surface 10 and restrained to the ring 8 through known means. Inside said filtering surface, preferably cylindrical, runs the aspiration pipe which is provided at the end with one or more slots for the entry of the fluid. In this drawing, one of said slots 11 can only be seen behind the meshes of the filtering surface 10.

FIG. 2 shows the case wherein the filter is immersed partially in the mud 12. Due to the arrangement of the slots 11 at the end of the aspiration pipe 5, even if part of the filtering surface 10 is exposed to the air, there is no entry of the latter in the aspiration pipe 5. The meshes of the lower part of the filter are not shown in order to highlight the arrangement of the slots 11 with reference to the level of the mud 12.

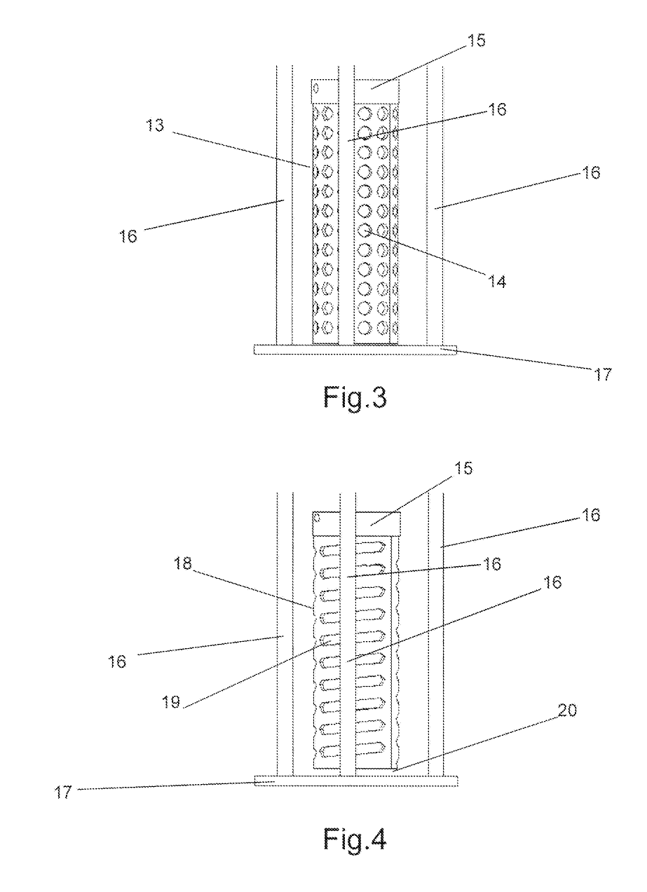

FIG. 3 shows the solution which provides for the use of a cleaner 13 made up of a cylindrical surface provided with appropriate circular holes 14, while neither the filtering surface nor the aspiration pipe, both internal and coaxial to this cleaner cylinder 13, are shown for clarity of representation. The ring 15 that restrains the cleaner 13 to the secondary shaft (not shown), is, in this case, a single body with said cleaner 13. Small circular protection columns 16 are also preferably mounted, attached with bolts to an underlying protection plate 17.

FIG. 4 shows, in particular, the cleaner cylinder 18 which is provided in this case with helical slots 19, which contribute to expelling the debris detached from the meshes of the filter and to pushing them downwards so that they can also exit from the slit 20 positioned between said cleaner cylinder 18 and the protection plate 17. The size of said slit 20 is exaggerated in this drawing for clarity of representation. As in FIG. 3 neither the filtering surface nor the aspiration pipe, both internal and coaxial to this cleaner cylinder 18, is shown for clarity of representation. Also in this case the ring 15 that restrains the cleaner 18 to the secondary shaft (not shown) is, in this case, a single body with said cleaner 18.

Variations in composition in relation to what is described are in any case possible, in any case coming within the scope of protection of this patent, according to what is stated in the claims.

What is claimed:

1. A system of filtration, preferably but not exclusively for oil drilling mud, equipped with at least one filtering surface, wherein said filtering surface develops in three dimensions and said system is provided with at least one cleaner of said filtering surface, mounted in such a way as not to have any reciprocal contact between said cleaner and said filtering surface.

2. The system of filtration, preferably but not exclusively for oil drilling mud, equipped with at least one filtering surface according to claim 1, wherein the minimum distance between a point of the surface of the cleaner of the filter and a point of the filtering surface is between 0.5 and 5 mm.

3. The system of filtration, preferably but not exclusively for oil drilling mud, equipped with at least one filtering surface according to claim 1, wherein said filtering surface has a cylindrical shape.

4. The system of filtration, preferably but not exclusively for oil drilling mud, equipped with at least one filtering surface according to claim 1, wherein said cleaner is made up of at least one elongated body structurally comparable to a beam rotating around the filtering surface via known means.

5. The system of filtration, preferably but not exclusively for oil drilling mud, equipped with at least one filtering surface according to claim 4, wherein the section perpendicular to the axis of development of said beam is triangular in shape.

6. The system of filtration, preferably but not exclusively for oil drilling mud, equipped with at least one filtering surface according to claim 1, wherein said cleaner is made up of at least one surface rotating around the filtering surface.

7. The system of filtration, preferably but not exclusively for oil drilling mud, equipped with at least one filtering surface according to claim 6, wherein said cleaning surface is provided with at least one hole.

8. The system of filtration, preferably but not exclusively for oil drilling mud, equipped with at least one filtering surface according to claim 7, wherein said at least one hole has a circular shape.

9. The system of filtration, preferably but not exclusively for oil drilling mud, equipped with at least one filtering surface according to claim 7, wherein said at least one hole has an elongated and helical shape.

10. The system of filtration, preferably but not exclusively for oil drilling mud, equipped with at least one filtering surface according to claim 3, wherein said cleaning surface is preferably cylindrical and coaxial to the filtering surface.

11. The system of filtration, preferably but not exclusively for oil drilling mud, equipped with at least one filtering surface according to claim 1, wherein said cleaner is moved by a rotating member, through a known structural coupling with the latter.

12. The system of filtration, preferably but not exclusively for oil drilling mud, equipped with at least one filtering surface according to claim 11, wherein said rotating member is driven by a known feed motor.

13. The system of filtration, preferably but not exclusively for oil drilling mud, equipped with at least one filtering surface according to claim 3, wherein said rotating member is made up of a shaft preferably coaxial to the axis of the cylindrical surface of the filter.

14. The system of filtration, preferably but not exclusively for oil drilling mud, equipped with at least one filtering surface according to claim 1, wherein said system of filtration is provided with at least one conduit for the aspiration of a certain flow of filtered fluid.

15. The system of filtration, preferably but not exclusively for oil drilling mud, equipped with at least one filtering surface according to claim 3, wherein said conduit is coaxial to the axis of the cylindrical filtering surface.

16. The system of filtration, preferably but not exclusively for oil drilling mud, equipped with at least one filtering surface according to claim 14, wherein said conduit is provided at the lower end with at least one slot for the entry of the fluid.

17. The system of filtration, preferably but not exclusively for oil drilling mud, equipped with at least one filtering surface according to claim 6, wherein the at least one filtering surface has a protection plate below the cleaning surface, said plate being detached from said cleaning surface by a slit, preferably circular.
